(19) United States
(12) Patent Application Publication
(10) Pub. No.: US 2025/0382499 A1
(43) Pub. Date: Dec. 18, 2025

(54) WATERBORNE COATING FORMULATION WITH POLYHEDRAL OLIGOMERIC SILSESQUIOXANE, SYNTHETIC METHOD AND APPLICATION THEREOF

(71) Applicant: Nano and Advanced Materials Institute Limited, Hong Kong (HK)

(72) Inventors: Chui Wan TSE, Hong Kong (HK); Chun Lung CHOI, Hong Kong (HK); Yubo CHENG, Hong Kong (HK); Yong ZHU, Hong Kong (HK); Li FU, Hong Kong (HK); Chenmin LIU, Hong Kong (HK)

(21) Appl. No.: 19/221,571

(22) Filed: May 29, 2025

Related U.S. Application Data
(60) Provisional application No. 63/659,344, filed on Jun. 13, 2024.

(51) Int. Cl. C09D 183/06; C09D 7/20

(52) U.S. Cl. CPC C09D 183/06; C09D 7/20

(57) ABSTRACT

The present invention relates to waterborne coating formulations with polyhedral oligomeric silsesquioxane for hard coating application. The coating composition includes a functionalized polymeric hard coating material, at least one co-polymerizable reactive diluent, a photo initiator or a thermal initiator, and one or more additives. The coating composition can be applied on polycarbonate (PC) film, polyethylene terephthalate (PET) film and paper by conventional coating techniques. The waterborne hard coating features a pencil hardness of more than 4H on PC and PET. The coating developed by internal and external emulsification of POSS which is used as a protective topcoat for various substrates. The resulting coating with high transparency and excellent anti-scratch resistance.

### CROSS-REFERENCE TO RELATED APPLICATIONS

The present application claims the priorities from the U.S. provisional patent application Ser. No. 63/659,344 filed Jun. 13, 2024, and the disclosure of which is incorporated herein by reference in its entirety.

### FIELD OF THE INVENTION

The present invention relates to waterborne coating formulations with polyhedral oligomeric silsesquioxane (POSS) for hard coating application. Moreover, the present invention meets the requirements for applications in high-end packaging, specifically in cases where only waterborne coating is permissible.

### BACKGROUND OF THE INVENTION

Coating materials are generally classified as solvent based and water based. Traditional solvent-based organic coatings contain large amounts of volatile organic compounds (VOCs), which are harmful to atmosphere and human health. Although a solvent-based coating formulation still makes up the largest share of coating resins, consumers are increasingly shifting towards environmentally friendly alternatives like waterborne or solventless technologies. They are applied in different ways including decorative appearance, protective barrier and different form of consumables products. The basic requirement of coating includes providing protection against scratches, abrasion, chemical attack, or corrosion.

In recent years, the development of hard coatings using organic-inorganic hybrid materials, such as polyhedral oligomeric silsesquioxane (POSS), has attracted significant attention for its potential as a protective topcoat in various applications. POSS, a silica nanoparticle with a silica cage core and organic functional groups attached to the cage vertex, has been incorporated as a filler or part of the coating component to enhance hardness and mechanical strength. The unique structure of POSS—comprising rigid inorganic cores and flexible organic backbones—makes it highly versatile, enabling the creation of hybrid materials with tailored functions. Possessing excellent thermal and mechanical properties, along with high compatibility in different systems, has fueled the growing interest in POSS-based coatings. Furthermore, with increasing environmental concerns, there is a shift in the industry from solvent-based coatings to waterborne systems, which offer benefits like low odor and reduced environmental impact. As a result, research into waterborne coatings has intensified.

CN Patent Application Publication No. CN103360586A discloses a POSS modified water-soluble polyester resin. The water-soluble polyester resin has low viscosity and good water solubility. It provides good adhesive force, hardness and impact strength, better flexibility and excellent mechanical properties. The hardness of the coating is about 2H.

CN Patent Application Publication No. CN105273557A discloses an invention that relates to a preparation of waterborne wood paint with nanofibrils microcrystalline cellulose (NFC) to improve the hardness of the paint. The preparation method includes: pre-emulsification by adding monomer, a hard monomer, a crosslinking monomer, an emulsifier and nano-cellulose, and conducting mixing with deionized water. The prepared waterborne wood paint has better paint film hardness and wood adhesion. The hardness of the wood paint is about HB to 3B.

CN Patent Application Publication No. CN106752726A discloses a preparation of water-based epoxy coal tar anti-corrosion coating which is prepared from a component A and a component B, wherein the component A is bisphenol A solid epoxy resin, and coal tar pitch, a fire-retardant fire retardant includes polyhedral silsesquioxane, a cosolvent and an emulsifier; and the component B is a water-based epoxy solidifier. The water-based epoxy coal tar anti-corrosion coating has good water resistance, anti-permeability, resistant to anti chemical corrosion and oil-resistant; high in hardness, impact-resistant, anti-wear which could be used for construction application.

CN Patent Application Publication No. CN106947030A discloses a POSS-based hybrid polyacrylate emulsion and its preparation method and application. The POSS-based hybrid polyacrylate emulsion comprises deionized water, monomer pre-emulsion, a shell monomer pre-emulsion and initiator. The water-borne POSS-based hybrid polyacrylate emulsion was used as a film-formation base material for wood paint with high hardness, good gloss, high fullness, scratch-resistance and excellent water resistance.

However, despite significant advancements in POSS-modified coatings, existing technologies face several critical limitations. One major challenge is achieving a stable and effective balance between antifouling performance and consistent water dispersibility, which remains a difficult task in current formulations. Moreover, the development of waterborne coatings still suffers from multiple issues. The use of long-chain polymeric emulsions in waterborne coating formulations leads to lower crosslinking density, adversely affecting the final hardness and durability of the coating. This insufficient crosslinking results in coatings that lack the required mechanical strength and longevity. Additionally, emulsions are not naturally stable and require precise formulation techniques to stabilize the dispersion, complicating the production process and reducing the shelf life of the products. Even when emulsions are successfully created, the presence of emulsifier residues after polymerization can distort the transparency of the coating, compromising its aesthetic appeal.

Furthermore, specific substrates like polycarbonate (PC) and varnished paper are particularly sensitive to organic solvents, which can damage the surface and degrade printed patterns. Waterborne coatings are essential for preventing such damage; however, the lack of effective waterborne formulations that offer high performance, stability, and compatibility with sensitive substrates remains a gap in current technology.

Thus, there is an urgent need for innovations that can address these critical issues. Specifically, the formulation of waterborne coatings with improved hardness, higher crosslinking density, and enhanced stability is desperately needed. Additionally, new technologies are required to reduce emulsifier residues, enhance the water dispersibility of hybrid coatings, and improve their antifouling performance without compromising transparency or adhesion to sensitive substrates.

### SUMMARY OF THE INVENTION

The invention described in the present application provides a significant advancement in the field of waterborne hard coatings by addressing key challenges such as insufficient cross-linking density, poor emulsion stability, and compromised optical properties of the coating film. The novel approach of simultaneously employing both internal and external emulsification steps stands out as a major innovation.

In particular, the present invention provides a waterborne coating formulation, which includes a functionalized polymeric hard coating material, at least one co-polymerizable reactive diluent, at least one additive and a photo initiator or a thermal initiator.

The functionalized polymeric hard coating material includes one or more thoroughly modified polyhedral oligomeric silsesquioxanes (POSS). The co-polymerizable reactive diluent contains one or more functional groups that co-polymerize with the functionalized polymeric hard coating material. The waterborne coating formulation is in a liquid form before curing.

The waterborne coating formulation is prepared through a process involving a combination of both internal emulsification and external emulsification techniques, forming a stable emulsion with an improved crosslinking density by at least 10% compared to conventional waterborne coatings.

In accordance to one embodiment, the waterborne coating formulation contains 10 to 55 wt % of the functionalized polymeric hard coating material, 0.1 to 40 wt % of the at least one co-polymerizable reactive diluent, and 0.1 to 5 wt % of the photo initiator or the thermal initiator.

In accordance to one embodiment, the functionalized polymeric hard coating material has one or more thoroughly modified POSS. The one or more thoroughly modified polyhedral oligomeric silsesquioxanes are represented by one of the following formulae for a bendable, transparent, and photo/thermal curable coating from:

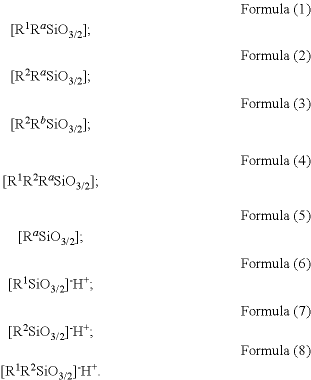

R¹ includes at least one epoxy or glycidyl-containing group; R² includes at least one photo/thermal curable crosslinking group; R^{a} includes at least one hydrophilic group; R^{b} includes a substituent or an adduct derived from the R² with a modifying reagent, and the substituent includes at least one hydrophilic group.

In accordance to one embodiment, the molar ratio of R¹ to R² ranges from 1:99 to 99:1, the molar ratio of overall R¹ and R² groups to overall R^{a} groups ranged from 1:99 to 99:1, the molar ratio of overall R² groups to overall R^{b} groups ranged from 1:99 to 99:1, and the molar ratio of overall hydrophilic groups to photo/thermal curable crosslinking groups ranges from 1:99 to 99:1.

In accordance to one embodiment, the one or more thoroughly modified polyhedral oligomeric silsesquioxanes are represented by the following formulae:

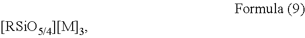

where R is an organic group, M is a cation. The organic group R can be selected based on the desired end-use application and may include epoxy or glycidyl-containing groups, photo- or thermal-curable crosslinking groups, hydrophilic groups, or hydrophobic groups. The cation M may be selected from alkali metals such as lithium (Li), sodium (Na), or potassium (K).

In accordance to one embodiment, the one or more thoroughly modified polyhedral oligomeric silsesquioxanes comprise

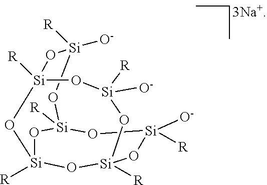

In accordance to one embodiment, the at least one epoxy or glycidyl-containing group is selected from a group consisting of epoxy, epoxy cyclohexane, epoxypropoxy, cycloaliphatic epoxy, epoxidized olefins glycidyl, and glycidyl ether.

In accordance to one embodiment, the at least one photo/thermal curable crosslinking group is selected form a group consisting of amine, oxetane, epi sulfide, acrylate, methacrylate, thiol-acrylate, thiol-methacrylate, acrylamide, vinyl sulfide, vinyl ether, styrene, norborneyl, cyclopentadiene, and acryloxypropyl.

In accordance to one embodiment, the at least one hydrophilic group is selected from a group consisting of carboxyl group, ammonium group, and polyethylene glycol (PEG) group.

In accordance to one embodiment, the at least one substituent or an adducted hydrophilic group is selected from a group consisting of 3-mercapto-1-propane sulfonate salt, 2-mercaptoethanesulfonate salt, mercaptosuccinic acid, and 2,3-dimercaptopropanesulfonate salt.

In accordance to one embodiment, the photo initiator is selected from a group consisting of aromatic phosphine oxides, diaromatic propanones, sulfonium salts, iodonium salts, selenium salts, ammonium salts, phosphonium salts, and transition metal complexes, while the thermal initiator is selected from a group consisting of organic peroxides, Lewis acid halides, transition metal complexes, and transition metal carbine complexes.

In accordance to one embodiment, the co-polymerizable reactive diluent is a curable compound selected from hydroxyl, thiol, amine, carboxyl, anhydride, epoxy, epoxy cyclohexane, epoxypropoxy, cycloaliphatic epoxy, epoxidized olefins, glycidyl ether, oxetane, episulfide, acrylate, methacrylate, thiol-acrylate, thiol-methacrylate, acrylamide, vinyl sulfide, styrene, vinyl ether, styrene, norborneyl and cyclopentadiene.

In accordance to one embodiment, the at least one additive includes a diluting solvent, a surfactant, or a leveling agent.

The one or more thoroughly modified polyhedral oligomeric silsesquioxanes are prepared through a process involving internal emulsification, external emulsification or a combination of both to form a stable emulsion and increase the cross-linking density by at least 10%. External emulsification will be used to maintain a high cross link density and by partially functionalized hydrophilic group as internal emulsification will be used to provide good emulsion stability. The specific sequence of emulsification depends on the desired overall performance, and the optimal formulation is chosen based on the performance requirements.

In a second aspect, the present invention provides a waterborne, transparent and flexible hard-coating film, which includes a substrate and a coating layer applied to the substrate. The coating layer is composed of the innovative waterborne coating formulation described earlier, which incorporates a carefully engineered balance of internal and external emulsification techniques. This unique formulation results in a coating that not only exhibits superior hardness and high cross-linking density, but also maintains excellent flexibility and durability. The coating demonstrates an elongation recovery of approximately 80%, ensuring resilience under stress, while its Young's modulus exceeds 3 GPa, indicating a strong and rigid material structure. The resulting hard-coating film demonstrates exceptional out-fold and in-fold abilities, meaning it can withstand repeated bending without permanent deformation or fracture. This level of flexibility, combined with the high mechanical strength imparted by the cross-linked network, makes the coating particularly suitable for demanding applications where both protection and flexibility are critical. Moreover, the transparency of the coating ensures that aesthetic properties are not compromised, making it ideal for use in applications where visual clarity is essential, such as in electronics or optical devices.

In accordance to one embodiment, the substrate includes colorless polyimide (CPI), polyimide (PI), polyethylene terephthalate (PET), polyamide (PA), thermoplastic polyurethane (TPU), ultra-thin glass (UTG), poly (methyl methacrylate) (PMMA), polypropylene (PP), polycarbonate (PC), metal, glass, wood and marble.

In accordance to one embodiment, the waterborne, transparent and flexible hard-coating film has a thickness of 1-100 μm.

In accordance to one embodiment, the waterborne, transparent and flexible hard-coating film exhibits a pencil hardness of at least 4H.

In accordance to one embodiment, the waterborne, transparent and flexible hard-coating film demonstrates a scratch resistance of 0.5 kg/cm² for over 30 passes.

In accordance to one embodiment, the waterborne, transparent and flexible hard-coating film has a light transparency of at least 85%.

In a third aspect, the present invention provides a method for preparing the waterborne, transparent, and flexible hard-coating film. This method involves the use of both external and internal emulsification techniques to formulate a waterborne coating solution that achieves a high cross-linking density for enhanced coating hardness, as well as excellent emulsion stability. By carefully controlling the emulsification process, the invention allows for a coating with optimal dispersion and a uniform network structure that is crucial for achieving consistent performance. The result is a highly durable, flexible, and transparent coating film that offers excellent resistance to mechanical stresses, as well as enhanced durability in real-world applications.

In accordance to one embodiment, the step of curing comprises thermal curing or photo curing, and the coated substrate is cured under either visible light, UV irradiation exposure, LED irradiation, electron beam irradiation, or at elevated temperature ranging from 25° C. to 200° C.

In accordance to one embodiment, the substrate includes colorless polyimide (CPI), polyimide (PI), polyethylene terephthalate (PET), polyamide (PA), thermoplastic polyurethane (TPU), ultra-thin glass (UTG), poly (methyl methacrylate) (PMMA), polypropylene (PP), polycarbonate (PC), metal, glass, wood and marble.

The method is not only effective in creating coatings with superior properties but also offers a practical, scalable solution for producing coatings with consistent quality, making it highly suitable for industrial applications that require both high performance and environmental sustainability.

### BRIEF DESCRIPTION OF THE DRAWINGS

Embodiments of the invention are described in more details hereinafter with reference to the drawings, in which:

FIG. 1A the synthetic method for mono-functional curable POSS.

FIG. 1B shows an example of a functionalized polymeric hard coating material with internal emulsification in accordance with the present invention;

FIG. 2A shows a schematic flow chart of the overall process of preparing a modified, functionalized POSS in accordance with the present invention.

FIG. 2B shows a schematic diagram of thoroughly modified POSS obtained through the internal emulsion.

FIG. 2C shows a schematic diagram of thoroughly modified POSS obtained through the external emulsion; and

FIG. 3 shows a schematic diagram of the overall process of preparing a thoroughly modified POSS, mixing, casting and the curing process.

### DETAILED DESCRIPTION

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

“Internal emulsification” refers to the reaction/grafting of hydrophilic group on the POSS unit, which will increase the solubility of the POSS unit.

“External emulsification” involves the additional incorporation of an emulsifier containing both hydrophilic and lipophilic components, in which the hydrophilic group does not impede the POSS structure.

As used herein, the term “hydrophilic resin component” refers to a water-compatible polymeric or oligomeric material that is dispersible or soluble in an aqueous medium. Examples include acrylic emulsions, polyurethane dispersions, or waterborne polyesters. This component enhances compatibility with the aqueous medium and contributes to film-forming properties.

The term “flexible substrate” refers to a base material capable of withstanding bending or deformation without cracking or losing functionality.

The phrase “transparent hard coating film” refers to a cured coating layer having a light transmittance of at least 85% in the visible spectrum (400-700 nm) and a pencil hardness of at least 4H under a 750 g load, as measured according to ASTM D3363. The film provides surface protection while maintaining optical clarity.

The term “high solid content” refers to a coating formulation wherein the total non- volatile content exceeds 30% by weight, preferably 40-60% by weight. This enables faster drying and reduced environmental impact compared to conventional low-solids systems.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

The present invention will be described in detail through the following embodiments. It should be understood that the specific embodiments are provided for an illustrative purpose only and should not be interpreted in a limiting manner. Those skilled in the art will appreciate that the invention described herein is susceptible to variations and modifications other than those specifically described.

The invention includes all such variation and modifications. The invention also includes all the steps and features referred to or indicated in the specification, individually or collectively, and any and all combinations or any two or more of the steps or features. Other aspects and advantages of the invention will be apparent to those skilled in the art from a review of the ensuing description.

The present invention provides a novel waterborne, transparent, and flexible hard coating film utilizing a thoroughly modified polymeric hard coating material, namely functionalized polyhedral oligomeric silsesquioxane (POSS), which is well synthesized by introducing hydrophilic groups into hydrophobic POSS or reacted with chemicals to form a charged molecule. Unlike conventional hydrophobic POSS materials that require organic solvents and suffer from poor water dispersibility and low emulsion stability, the present invention achieves a highly stable and effective waterborne system through selective functionalization and a dual emulsification strategy.

One of the key innovations lies in the tailored molecular structure of POSS, which is modified with at least one hydrophilic group (R^{a}), in combination with at least one photo-or thermal-curable crosslinking group (R²) and optionally an epoxy or glycidyl-containing group (R¹). The controlled introduction of these functional groups allows precise tuning of water dispersibility, crosslinking behavior, and reactivity with other formulation components. The resultant POSS structure is amphiphilic in nature, enabling its use in both internal and external emulsification methods to achieve high dispersion stability and enhanced crosslinking density.

In one embodiment, the thoroughly modified POSS can be represented by one of the following formulae:

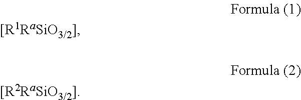

R¹ includes at least one epoxy or glycidyl-containing group. R² includes at least one photo/thermal curable crosslinking group or other functional groups. R^{a} includes at least one hydrophilic group.

R¹ can be selected from epoxy, epoxy cyclohexane, epoxypropoxy, cycloaliphatic epoxy, epoxidized olefins glycidyl, glycidyl ether, or a combination thereof.

R² can be selected from amine, oxetane, episulfide, acrylate, methacrylate, thiol-acrylate, thiol-methacrylate, acrylamide, vinyl sulfide, vinyl ether, styrene, norborneyl, cyclopentadiene and acryloxypropyl. The other functional groups can be selected from, but not limited to fluorocarbon, thiol and amine.

R^{a} can be selected from carboxyl group, ammonium group and polyethylene glycol (PEG) group.

In one embodiment, the molar ratio of overall R¹ and R² groups to overall R^{a} groups ranges from 1:99 to 99:1.

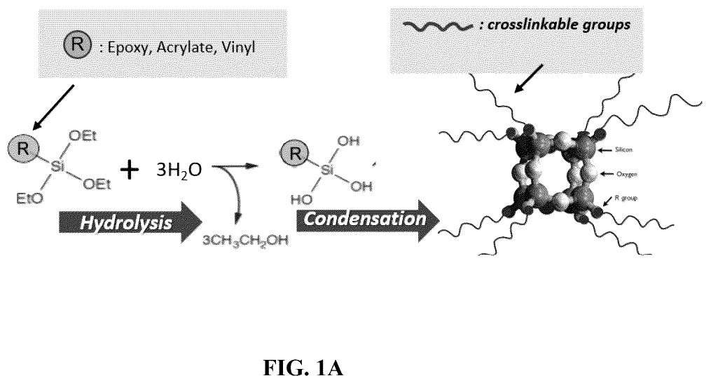

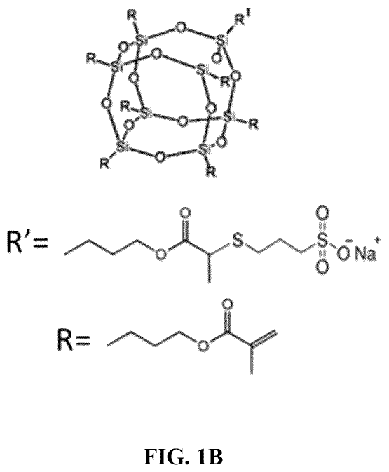

In another embodiment, the mono-functional curable POSS is derived from a corresponding trifunctional hydrolysable silane compound through hydrolysis and condensation reaction (FIG. 1A). The mono-functional hydrophobic POSS includes the following Formula (9):

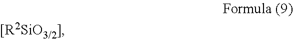

R² in the Formula (9) is substituted to obtain the thoroughly modified POSS, which can be represented by the following formulae:

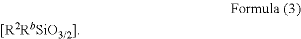

R^{b} includes a substituent or an adduct derived from the R² with a modifying reagent. Examples of the substituent include 3-mercapto-1-propane sulfonate salt, 2-mercaptoethanesulfonate salt, mercaptosuccinic acid and 2,3-dimercaptopropane-sulfonate salt.

The substituent in R^{b} may be at least one hydrophilic group. Examples of the hydrophilic group may include polyethylene glycol N-[tris(hydroxymethyl)methyl]-2-aminoethanesulfonic acid salt, diphenyl-amine-4-sulfonate salt, N-methyl sulfanilic acid salt, 3-(cyclohexylamino)-1-propanesulfonic acid and 2-aminoethanesulfonic acid.

In one embodiment, the modifying reagent is an organic chain structured compound structured as a linear or branched organic chain structure terminated with a reactive functional group at one terminal or pendant in structure. The reactive functional group may include hydroxyl, thiol, amine, carboxyl, anhydride, or any combination thereof.

In one embodiment, the molar ratio of overall R² groups to overall R^{b} groups ranges from 1:99 to 99:1.

In one embodiment, the molar ratio of overall hydrophilic groups to photo/thermal curable crosslinking groups ranges from 1:99 to 99:1.

In another embodiment, the thoroughly modified POSS can be represented by the following formulae:

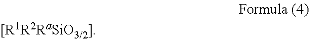

The hydrophobic POSS may further include one or more multi-functional crosslinking groups. The multi-functional hydrophobic POSS are synthesized via hydrolytic co-condensation of two functionalized trifunctional silane compounds.

In another embodiment, the thoroughly modified POSS can be represented by the following formulae:

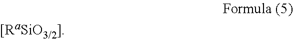

The thoroughly modified POSS are derived from a corresponding trifunctional hydrolysable silane compound through hydrolysis and condensation reaction.

The functionalized POSS is hydrophilic. For instance, it can be uniformly dissolved in various hydrophilic solvents, such as water and methanol. FIG. 1B demonstrates one of the structures of the hydrophilic modified POSS structure.

In one embodiment, the functionalized POSS can feature a cage, half-cage, ladder structure, or any combination of these.

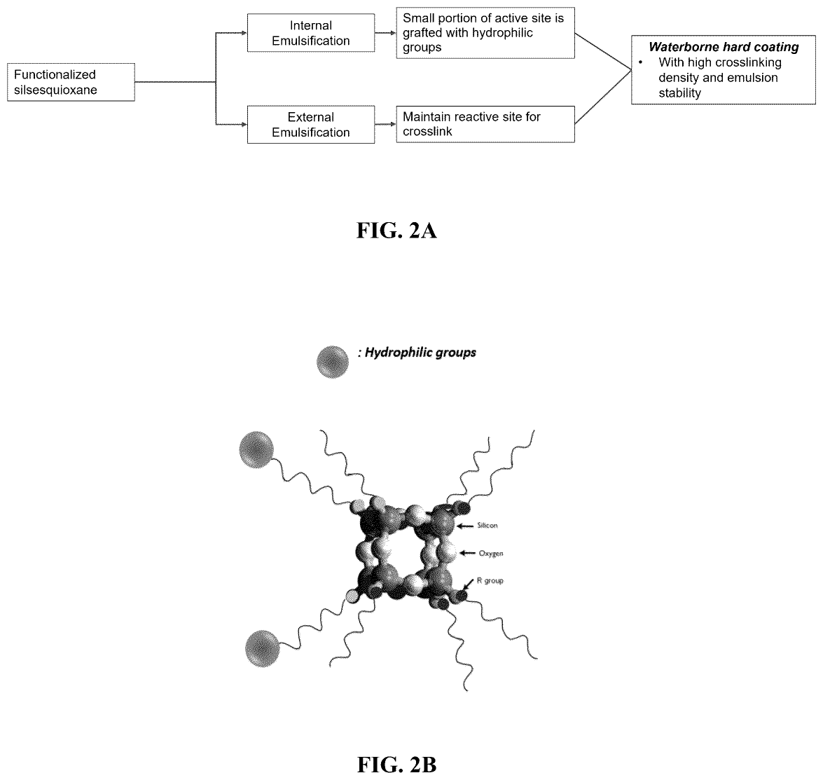

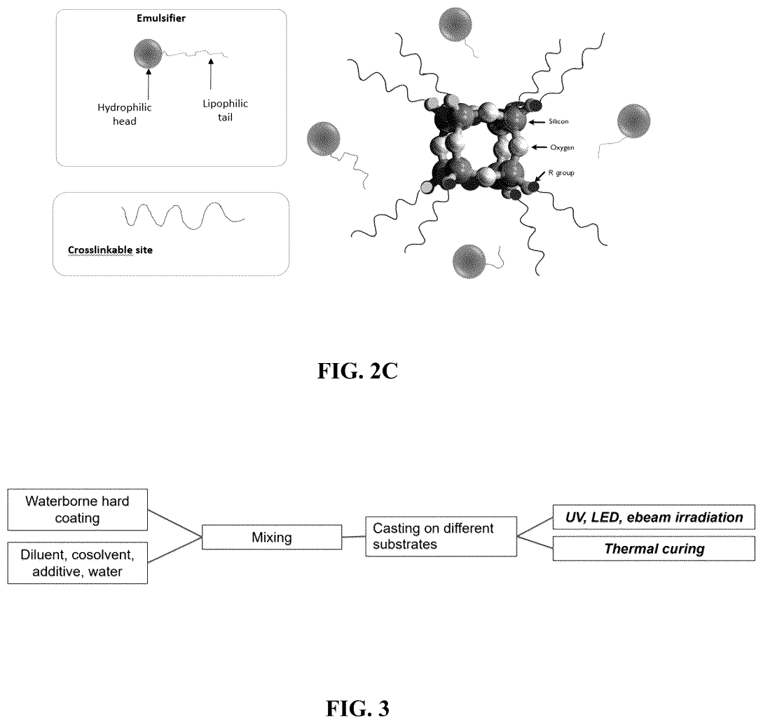

The waterborne coating formulation with modified POSS structure can be prepared by internal and/or external emulsification, as shown in FIG. 2A. Depending on the characteristics and solubility of the components in the formulation, internal or external emulsification can be carried out first, followed by combining the two. This helps to avoid mutual interference and instability during the emulsification process.

External emulsification is utilized to ensure a high cross-linking density within the coating material, which enhances the mechanical strength and durability of the final film. This process helps maintain a robust and stable network structure, contributing to improved hardness and longevity of the coating. On the other hand, internal emulsification, facilitated by the partial functionalization of hydrophilic groups, provides excellent emulsion stability. This allows for better dispersion and consistent quality throughout the formulation, ensuring that the waterborne coating remains stable over time without compromising its performance.

By combining these two emulsification methods, the invention not only addresses the issue of low cross-linking density commonly seen in traditional waterborne coatings but also ensures that the emulsion remains stable and optically clear. This dual emulsification strategy offers a balanced approach, providing both high performance in terms of hardness and durability, and optimal stability for long-term use. The increase in cross-linking density by at least 10% further enhances the overall mechanical properties of the coating, making it highly effective for a range of applications that require both resilience and aesthetic appeal.

FIG. 2B illustrates a schematic diagram of the POSS structure obtained after internal emulsification. It demonstrates that hydrophilic groups have been grafted onto the functional group on the POSS unit. This modification enables the formation of a stable emulsion with a zeta potential exceeding 30 mV.

In addition, FIG. 2C illustrates a schematic diagram of the POSS structure obtained after external emulsification. FIG. 2C shows that with the further addition of an emulsifier containing both hydrophilic and lipophilic components, a notable distinction from internal emulsion arises: the hydrophilic group does not impede the POSS structure. This may result in the creation of an emulsion with a high cross-linking density because the addition of an emulsifier possessing both hydrophilic and lipophilic properties could contribute to the formation of more cross-linking points within the emulsion. The hydrophilic groups are capable of interacting with the aqueous phase, while the lipophilic groups can interact with the oil phase. This dual affinity may facilitate the distribution of the emulsifier at the interface between the aqueous and oil phases, thereby promoting the formation of cross-linking points.

In one embodiment, the thoroughly modified POSS can be prepared by using an external reagent such as acidic reagent as shown in Formula (6) to (8):

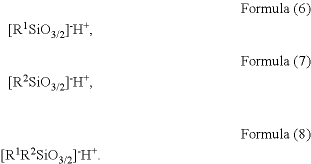

Firstly, functionalized hydrophobic POSS are derived from a corresponding trifunctional hydrolyzable silane compound through hydrolysis and condensation reaction. The mono-functional hydrophobic POSS includes the following Formula (10) and (11):

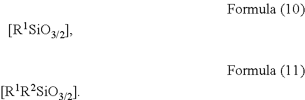

The POSS represented by Formula (10) and Formula (11) are synthesized by hydrolytic condensation, and wherein the molar ratio of R¹ to R² ranges from 1:99 to 99:1, and protonating the R¹ in Formula (10) or R¹ and R² in Formula (11) by inorganic-phase acid or organic-phase acid to obtain the thoroughly modified POSS shown in Formula (6) to (8). The weight ratio of inorganic-phase acid or organic-phase acid to POSS represented by Formula (9) or Formula (10) or Formula (11) ranges from 20:80 to 50:50.

In another aspect, the present invention provides a coating formulation, which contains 10 to 55 wt % of aforementioned waterborne polymeric hard coating material, 0.1 to 40 wt % of co-polymerizable reactive diluent, and 0.1 to 5 wt % of photo/thermal initiator. The coating formulation is in liquid form before photo/thermal curing.

In one embodiment, the photo initiator may include aromatic phosphine oxides, diaromatic propanones, sulfonium salts, iodonium salts, selenium salts, ammonium salts, phosphonium salts and transition metal complexes. The thermal initiator includes organic peroxides, Lewis acid halides, transition metal complexes and transition metal carbine complexes.

The choice of initiators depends on which polymerization mechanism the thoroughly modified, functionalized POSS can go through. Both the thermal initiator and the photo initiator components can be used solely, or in combinations.

In one embodiment, the co-polymerizable reactive diluent may include functional groups that co-polymerize with the thoroughly modified, functionalized polymeric hard coating material. The co-polymerizable reactive diluent is a curable compound selected from hydroxyl, thiol, amine, carboxyl, anhydride, epoxy, epoxy cyclohexane, epoxypropoxy, cycloaliphatic epoxy, epoxidized olefins, glycidyl ether, oxetane, episulfide, acrylate, methacrylate, thiol-acrylate, thiol-methacrylate, acrylamide, vinyl sulfide, styrene, vinyl ether, styrene, norborneyl and cyclopentadiene.

In certain applications, the coating formulation may further contain one or more additives, such as less than 90 wt % of diluting solvent, or less than 10 wt % of surfactant, or less than 5 wt % of leveling agent.

The diluting solvent includes organic solvent and water. The organic solvent is in a range of less than 5%. Alcohol such as methanol, ethanol, isopropyl alcohol, and butanol can be used. The surfactant can be any of anionic surfactants, cationic surfactants, amphoteric surfactants, zwitterionic surfactants, nonionic surfactants. For instance, the surfactant can be sodium dodecyl sulfate, cetyltrimethyl ammonium bromide.

Notably, the composition is in a liquid form before curing. The formulation is compatible with multiple curing methods. For instance, the waterborne hard coating formulation may undergo photo-curing via UV, LED, or e-beam exposure, or it can opt for thermal curing. Such flexibility enables adaptation to different manufacturing workflows and substrates, especially in fields where process temperature constraints or substrate compatibility is critical.

The cured composition preferably has a high pencil hardness equal to or higher than 4H on flexible substrates, and high transparency of at least 85% and anti-scratch ability. Moreover, the cured composition has excellent flexibility and durability for folding to a bending radius of 2 mm over more than 160000 cycles without damage and cracking. The durability for out-folding to a bending radius of 6 mm over more than 80,000 cycles.

In addition, the waterborne coating formulation possesses stability in which magnitude of measured zeta potential will not less than 30 mV and no visible gelling or aggregation after 24 hours. This ensures long shelf life and consistent application performance, addressing a major limitation of conventional hard coating dispersions which often suffer from gelling or phase instability during storage or processing.

In a further aspect, the present invention provides a waterborne, transparent and flexible hard-coating film, which includes a substrate and a coating on the substrate. In particular, the coating formulation contains the thoroughly modified POSS, making the prepared coating bendable, transparent, and photo/thermal curable coating. FIG. 3 illustrates the schematic diagram outlining the entire process for preparing a waterborne, transparent and flexible hard-coating film, including mixing, casting, and the curing process.

The formulation can be casted on the substrate, and the coated substrate is dried at temperatures ranging from 25 to 120° C. Afterward, the coated substrate undergoes either photo/thermal curing, exposed to LED, UV, or e-beam irradiation, or elevated temperatures ranging from 25 to 200° C., resulting in the formation of the hard coating.

After curing, the waterborne coating is used as an anti-scratch protecting coating layer on various substrates, which possess high surface hardness, high transparency and a certain degree of flexibility.

Examples of the flexible substrate include colorless polyimide (CPI), polyimide (PI), polyethylene terephthalate (PET), polyamide (PA), thermoplastic polyurethane (TPU), ultra-thin glass (UTG), poly(methyl methacrylate) (PMMA), polypropylene (PP), polycarbonate (PC). Examples of the rigid substrate include metal, glass, wood and marble.

Unlike existing POSS-based systems that are primarily hydrophobic and incompatible with waterborne systems, the present invention introduces a class of POSS materials that are not only water-compatible but also curable under ambient or low-energy conditions. The high solubility of the modified POSS in aqueous solvents such as methanol or water, combined with their ability to form transparent and flexible films, distinguishes this invention from hydrophobic or solvent-based coating technologies.

Moreover, existing waterborne coatings generally suffer from poor hardness or mechanical integrity due to low crosslinking density. The present invention addresses this shortcoming by enhancing POSS with multiple crosslinking points and enabling a two-stage emulsification process that avoids mutual incompatibility and instability. This ensures high durability, flexibility (withstanding >160,000 bend cycles at a 2 mm radius), and scratch resistance-all of which are uncommon in conventional waterborne formulations.

Prior technologies also typically rely on resin blends or copolymerization systems that lack molecular-level control. In contrast, the current invention allows molecularly defined control over POSS cage functionalization, enabling reproducibility and formulation customization for diverse substrates and applications.

The present waterborne coating formulation offers a wide range of potential applications across various industries. It can be used as a protective coating for electronics, such as smartphones and tablets, providing scratch resistance and durability while maintaining transparency. In the automotive industry, the coating can protect vehicle surfaces from scratches and environmental damage, while ensuring a high-quality finish. For architectural applications, the formulation can be applied to both exterior and interior surfaces, offering durability and flexibility against weathering, while maintaining aesthetic appeal. It also has significant potential in wood and furniture coatings, where it can provide protection against wear and tear, as well as flexibility to prevent cracking.

Additionally, the coating could be adapted for use in flexible packaging, offering enhanced durability and gloss, while remaining transparent. It can also be applied to textiles, providing water resistance and durability for outdoor fabrics or upholstery. The optical industry can benefit from this coating due to its transparency, flexibility, and potential for features like anti-smudge and anti-glare properties. In the marine sector, it can be used for antifouling and corrosion resistance on boats and marine equipment. Lastly, it is suitable for floor coatings in high-traffic areas, offering long-lasting protection against abrasion and stains. This versatile formulation, with its environmental benefits, positions it as a sustainable alternative to traditional coatings in various applications.

In the following description, specific details are provided to offer a comprehensive understanding of the present invention, for explanatory purposes and not intended for limitation.

### EXAMPLE

### Preparation of Hydrophilic Functionalized Polyhedral Oligomeric Silsesquioxane (POSS)

### Example 1

3.54 g of 3-(2,3-epoxypropoxy)propyl trimethoxysilane and 2.62 g of 2-[Methoxy(polyethyleneoxy)-propyl] trimethoxysilane (6-9 PEG units) were mixed with 50-200 g of acetone in a reactor. Then, the mixture was reacted at 30-80° C. for 10 minutes, and 1.9 g of 20% aqueous solution of trimethylamine was added dropwise to the reaction mixture. The reaction conditions were kept at 30-80° C. for 30-300 minutes. Once the hydrolysis and condensation reactions were completed, the product in the reaction mixture was cooled and subjected to vacuum drying. This resulted in a hydrophilic PEG POSS with crosslinking epoxy functional groups (S1), presenting as a light brown liquid product. The structure could be tuned by changing the ratio of 3-(2,3-epoxypropoxy)propyl trimethoxysilane to 2-[Methoxy(polyethyleneoxy)propyl] trimethoxysilane or by changing the number of PEG units in 2-[Methoxy(polyethyleneoxy)propyl] trimethoxysilane or both.

### Example 2

3.69 g of 2-(3,4-epoxycyclohexyl) ethyl trimethoxysilane and 2.62 g of 2-[Methoxy(polyethyleneoxy)propyl] trimethoxysilane (6-9 PEG units) were mixed with 50-200 g of acetone in a reactor. Then, the mixture was reacted at 30-80° C. for 10 minutes, and 1.8 g of 17% aqueous solution of pyridine was added dropwise to the reaction mixture. The reaction conditions were kept at 30-80° C. for 30-300 minutes. Once the hydrolysis and condensation reactions were completed, the product in the reaction mixture was cooled and subjected to vacuum drying. This resulted in a hydrophilic PEG POSS containing crosslinking epoxycyclohexyl functional groups (S2), presenting as a light brown liquid product. The structure could be tuned by changing the ratio of 2-(3,4-epoxycyclohexyl)ethyl trimethoxysilane to 2-[Methoxy(polyethyleneoxy)propyl] trimethoxysilane or by changing the number of PEG units in 2-[Methoxy(polyethyleneoxy)propyl] trimethoxysilane or both.

### Example 3

3.51 g of 3-(acryloyloxy)propyl trimethoxysilane and 2.62 g of 2-[Methoxy(polyethyleneoxy)propyl] trimethoxysilane (6-9 PEG units), were mixed with 50-200 g of acetone in a reactor. Then, the mixture was reacted at 30-80° C. for 10 minutes, and 1.9 g of 20% aqueous solution of trimethylamine was added dropwise to the reaction mixture. The reaction conditions were kept at 30-80° C. for 30-300 minutes. Once the hydrolysis and condensation reactions were completed, the product in the reaction mixture was cooled and subjected to vacuum drying. This resulted in a hydrophilic PEG POSS containing crosslinking acryloyl functional groups (S3), presenting as a light brown liquid product. The structure could be tuned by changing the ratio of 3-(acryloyloxy)propyl trimethoxysilane or by changing the number of PEG units in 2-[Methoxy(polyethyleneoxy)propyl] trimethoxysilane or both.

### Example 4

1.77 g of 3-(2,3-epoxypropoxy)propyl trimethoxysilane, 1.76 g of 3-(acryloyloxy)propyl trimethoxysilane and 2.62 g of 2-[Methoxy(polyethyleneoxy)propyl] trimethoxysilane (6-9 PEG units), were mixed with 50-200 g of acetone in a reactor. Then, the mixture was reacted at 30-80° C. for 10 minutes, and 1.9 g of 20% aqueous solution of trimethylamine was added dropwise to the reaction mixture. The reaction conditions were kept at 30-80° C. for 30-300 minutes. Once the hydrolysis and condensation reactions were completed, the product in the reaction mixture was cooled and subjected to vacuum drying. This resulted in a hydrophilic PEG POSS containing two different crosslinking functional groups (S4), epoxy and acryloyl, which was a light brown liquid product. The structure could be tuned by changing the ratio between 3-(2,3-epoxypropoxy)propyl trimethoxysilane, 3-(acryloyloxy)propyl trimethoxysilane and 2-[Methoxy(polyethyleneoxy)propyl] trimethoxysilane or by changing the number of PEG units in [Methoxy(polyethyleneoxy)propyl] trimethoxysilane or both.

### Example 5

AryloPOSS was prepared with the method as described in US2021/0189173 A1. 50 g of 3-(acryloyloxy)propyl trimethoxysilane was mixed with 50-200 g of acetone in a reactor. Then, the mixture was reacted at 30-70° C. for 10 minutes, and 3-10 g of 5% aqueous solution of potassium carbonate was added dropwise to the reaction mixture. After 20 minutes, 50 g of water was added dropwise to the reaction mixture, and the reaction conditions were kept at 30-70° C. for 3-12 hours. After completion of the hydrolysis and condensation reactions, the product in the reaction mixture was cooled and washed with water and extracted with ethyl acetate. The upper layer was collected and dried with magnesium sulfate. Finally, the solvent in dried organic solution was distilled off at 60° C. This yielded an acrylate containing POSS.

1.32 g of AcryloPOSS and 10 mg butylhydroxytoluene were mixed in 20 g of methanol in a reactor. 10-30 g of methanol containing 0.36 g sodium 3-mercapto-1-propane sulfonate was added dropwise to the reaction mixture, and the reaction conditions were kept at 20-50° C. for 2-6 hours. After completion of the reaction, methanol was removed under vacuum. This yielded a sulfonate adduct to the acrylo group of POSS (S5), which was a colorless water-soluble liquid product.

### Example 6

### Preparation of a Waterborne, Transparent, and Flexible Hard-Coating Film

Firstly, a hard-coating solution was prepared by blending 50% by weight of an epoxy and acrylate-containing POSS (S2) synthesized in Example 2, 50% by weight of acetone and 8% by weight of diethylenetriamine. The prepared hard-coating solution was applied onto a PI film. The PI film coated with epoxy and acrylate containing POSS was put into an oven at 110° C. for 3 hours. This yielded a hard-coating film with the hard-coating layer.

Other hard-coating solutions (I to V) were prepared each by a procedure similar to that in Example 6, except for changing the formulation of the hard-coating composition, substrate, thickness and curing program as given in Table 1.

The performance of above-prepared hard-coating film was examined and assessed on various methods as follows:
(1) Pencil hardness: The pencil hardness of hard coat layer of the above-prepared hard coat film was assessed in conformity to JIS K 5600 May 4 and ISO 15184-980.
(2) Scratch resistance: Abrasion Resistance Tester (ZL-1073 supplied by Dongguan Zhongli Instrument Technology) and steel wool #0000 were used for abrasion tests. The hard coat layer of the prepared hard coat film was rubbed by reciprocating movements under a load of 0.5 kg/cm².

TABLE 1

| | Example | I | II | III | IV | V |
|---|---|---|---|---|---|---|
| POSS | S1 | 50% | — | — | — | — |
| | S2 | — | 50% | — | — | — |
| | S3 | — | — | 50% | — | — |
| | S4 | — | — | — | 50% | — |
| | S5 | — | — | — | — | 50% |
| Solvent | Water | 50% | 50% | 50% | 50% | 50% |
| Initiator | GARICURE ® PI | — | — | 2 wt % | 2 wt % | 2 wt % |
| | 6976 | | | POSS | POSS | POSS |
| | Diethylenetriamine | | — | — | 4 wt % | |
| | | | | | POSS | |
| | TPO | — | — | — | — | |
| | DOUBLECURE ® | — | — | — | — | |
| | 184 | | | | | |
| Surfactant | Sodium dodecyl | | | | | |
| | sulfate | | | | | |
| | Cetyltrimethyl | | | | | |
| | ammonium bromide | | | | | |
| Curing | Ultraviolet curing | 157 mw/cm² for 2 min | | | | |
| program | | | | | | |
| | Thermal curing | — | — | — | 110° C. | — |
| | | | | | 1 hour | |
| Substrate | | PET | PET | PET | PET | |
| Thickness | | 30 μm | 15 μm | 40 μm | 30 μm | |
| Pencil | | >4H | >4H | >4H | >4H | |
| hardness | | | | | | |
| Scratch | Scratch test not | 50 times | 30 times | 50 times | 30 times | |
| resistance | mentioned in claim | pass | pass | pass | pass | |
| (0.5 kg/cm²) | | | | | | |
| Light | % | >90 | >90 | >90 | >90 | |
| Transparency | | | | | | |

GARICURE® PI 6976 (Trademark Guarson, http://www.guarson.com/product_detail/id/11.html the disclosure of which is incorporated by reference herein): a photo-initiator comprising mixed triarylsulfonium hexafluoroantimonate Salts, in particular Sulfonium, (thiodi-4,1-phenylene)bis[diphenyl-, bis[hexafluoroantimonate & ulfonium, diphenyl[4-(phenylthio) phenyl]-, hexafluoroantimonate.

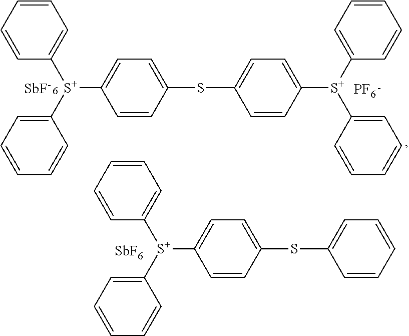

TPO: 2,4,6-trimethylbenzoyldiphenyl phosphine oxide, used as a free-radical initiator DOUBLECURE® 184 (Trademark of DBC Bonding, https://www.dbc.com.tw/products_detal.php?id=270&pid=67&sid=94 the disclosure of which is incorporated by reference herein): a free-radical initiator based on 1-Hydroxy-cyclohexyl-phenyl-ketone, CAS 947-19-3

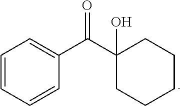 [SMILES: O=C(c1ccccc1)C1(O)CCCCC1]

### Example 7

A hard-coating solution was prepared by blending 50% by weight of an epoxy and acrylate-containing POSS (S2) synthesized in Example 2, 50% by weight of acetone and 8% by weight of diethylenetriamine. The above-prepared hard-coating solution was applied onto a PI film. The PI film coated with epoxy and acrylate-containing POSS was put into an oven at 110° C. for 3hours. This yielded a hard-coating film with the hard-coating layer. Hard-coating solutions were prepared each by a procedure similar to that in Example 6, except for changing the formulation of the hard-coating composition, substrate, thickness and curing program as given in Table 2.

TABLE 2

| | | Example | | |
|---|---|---|---|---|
| | | VI | VII | VIII |
| POSS | GlyPOSS | 50% | — | 25% |
| | CHOPOSS | — | 50% | 25% |
| Solvent | Water | 50% | 50% | 50% |
| Acid | Acetic acid | 10 wt % POSS | 10 wt % POSS | 10 wt % POSS |
| | Hydrochloric | | | |
| | acid | | | |
| Initiator | GARICURE ® | 2 wt % POSS | 2 wt % POSS | 2 wt % POSS |
| | PI 6976 | | | |
| Curing program | Ultraviolet | — | — | 157 mw/cm² |
| | curing | | | 2 min |
| | Thermal curing | 110° C. 3 hours | 110° C. 1 hour | — |
| Substrate | | PET/PC | PET | PI |
| Thickness | | 30 μm | 15 μm | 40 μm |
| Pencil hardness | | 7H | 7H | 7H |
| Scratch resistance | | 50 times | 30 times | 50 times |
| (0.5 kg/cm²) | | pass | pass | pass |
| Light Transparency | | >95% | >95% | >95% |

### Example 8

A comparative example was conducted to evaluate the dispersibility of hydrophobic polyhedral oligomeric silsesquioxane (POSS) in an aqueous medium. Specifically, 2 grams of hydrophobic POSS synthesized in Example 5 was added to 98 grams of deionized water under ambient conditions. The mixture was stirred at 800 rpm for 30 minutes using a magnetic stirrer. To facilitate dispersion, 5 wt % ethanol based on the total weight was subsequently introduced into the system, followed by continued stirring for an additional 30 minutes. Despite these efforts, substantial aggregation of the hydrophobic POSS was observed, and visible sedimentation occurred at the bottom of the container. No stable emulsion or uniform dispersion was formed. Zeta potential analysis indicated a value close to 0 mV, confirming the absence of electrostatic stabilization. An attempt was made to apply the resulting dispersion onto a polyethylene terephthalate (PET) substrate using a doctor blade technique, followed by drying at 60° C. for 30 minutes. The coated film exhibited severe cracking, discontinuous coverage, and poor adhesion, thereby failing to form an acceptable continuous coating layer. These results demonstrate that hydrophobic POSS lacking hydrophilic functionalization is incapable of forming a stable aqueous dispersion or producing a uniform waterborne coating film, underscoring the necessity of the hydrophilic modification and emulsification strategies disclosed in the present invention.

### Example 9

### Testing and Performance Of Waterborne, Transparent, and Flexible Hard-Coating Film

Table 1 illustrates a series of comparative examples (Examples I-V) in which different types of POSS compounds (S1-S5) were incorporated into a waterborne coating composition. Each composition contained 50 wt % water as solvent and varied in the type of POSS used: S1, S2, S3, S4, and S5. Initiators such as GARICURE® PI 6976 and diethylenetriamine were added at 2 wt % or 4 wt % relative to the POSS content to facilitate curing. In Examples III-V, ultraviolet (UV) curing was performed using an energy intensity of 157 mW/cm² for 2 minutes, and thermal curing was conducted at 110° C. for 1 hour as noted.

The coatings were applied to PET substrates with varying thicknesses ranging from 15 to 40 μm. Surface hardness was evaluated using a pencil hardness test, and all formulations exhibited excellent hardness of greater than 4H. Scratch resistance was assessed by applying a 0.5 kg/cm² load in a repeated scratch test. All coatings passed either 30 or 50 cycles depending on the formulation, indicating high durability. Furthermore, all samples exhibited excellent light transparency, with values exceeding 90%. These results demonstrate that regardless of the specific POSS used, the waterborne coatings maintain superior mechanical strength and optical clarity, thereby confirming the versatility and effectiveness of POSS in forming transparent hard coating films.

Table 2 presents additional examples (Examples VI-VIII) evaluating the effects of combining different POSS structures (GlyPOSS and CHOPOSS) with acidic additives and initiators on coating performance. In these examples, 50 wt % of either GlyPOSS or CHOPOSS was dissolved in water, and 10 wt % acid (relative to POSS) was added-specifically acetic acid or hydrochloric acid—to enhance hydrolysis and condensation. GARICURE® PI 6976 was used as the photo-initiator at 2 wt % POSS to enable ultraviolet curing, while some formulations also underwent thermal curing at either 110° C. for 1 hour or 3 hours, depending on the substrate.

Coatings were applied to PET, PET/PC, or PI substrates, with film thicknesses of 15 to 40 μm. All resulting films exhibited a pencil hardness of 7H, indicating significantly improved mechanical hardness compared to those in Table 1. Scratch resistance tests under a 0.5 kg/cm² load showed that all films successfully passed either 30 or 50 cycles, depending on film thickness and curing conditions. Notably, light transparency was even higher than the previous examples, with all samples achieving greater than 95% transmittance. These results demonstrate the synergistic effect of dual-functional POSS systems in combination with acid-catalyzed condensation and dual-cure processes, leading to enhanced mechanical performance and superior optical properties suitable for transparent protective coatings on flexible substrates.

What is claimed is:

1. A waterborne coating formulation, comprising:
a functionalized polymeric hard coating material, wherein the functionalized polymeric hard coating material comprises one or more thoroughly modified polyhedral oligomeric silsesquioxanes, wherein the thoroughly modified polyhedral oligomeric silsesquioxanes are functionalized with hydrophilic groups attached to crosslinkable groups on hydrophobic polyhedral oligomeric silsesquioxanes, and wherein modification is achieved through in situ synthesis using a strong base;
at least one co-polymerizable reactive diluent, wherein the co-polymerizable reactive diluent contains one or more functional groups that co-polymerize with the functionalized polymeric hard coating material;
at least one additive; and
a photo initiator or a thermal initiator,
wherein the waterborne coating formulation is in a liquid form before curing, and the waterborne coating formulation is prepared through a process involving a combination of both internal emulsification and external emulsification techniques, forming a stable emulsion with an improved crosslinking density by at least 10% compared to conventional waterborne coatings.

2. The waterborne coating formulation of claim 1, wherein the waterborne coating formulation comprises:
10 to 55 wt % of the functionalized polymeric hard coating material;
0.1 to 40 wt % of the at least one co-polymerizable reactive diluent; and
0.1 to 5 wt % of the photo initiator or the thermal initiator.

3. The waterborne coating formulation of claim 1, wherein the one or more thoroughly modified polyhedral oligomeric silsesquioxanes are represented by one of the following formulae for a bendable, transparent, and photo/thermal curable coating from: 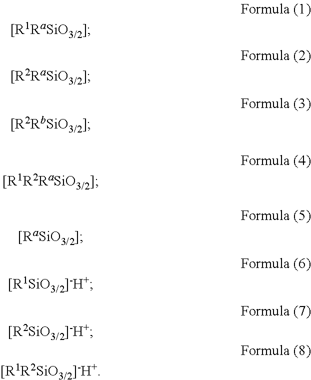
wherein R¹ comprises at least one epoxy or glycidyl-containing group; R² comprises at least one photo/thermal curable crosslinking group; R^{a} comprises at least one hydrophilic group; R^{b} comprises a substituent or an adduct derived from the R² with a modifying reagent, and the substituent comprises at least one hydrophilic group.

4. The waterborne coating formulation of claim 3, wherein the molar ratio of R¹ to R² ranges from 1:99 to 99:1, the molar ratio of overall R¹ and R² groups to overall R^{a} groups ranged from 1:99 to 99:1, the molar ratio of overall R² groups to overall R^{b} groups ranged from 1:99 to 99:1, and the molar ratio of overall hydrophilic groups to photo/thermal curable crosslinking groups ranges from 1:99 to 99:1.

5. The waterborne coating formulation of claim 3, wherein the at least one epoxy or glycidyl-containing group is selected from a group consisting of epoxy, epoxy cyclohexane, epoxypropoxy, cycloaliphatic epoxy, epoxidized olefins glycidyl, and glycidyl ether.

6. The waterborne coating formulation of claim 3, wherein the at least one photo/thermal curable crosslinking group is selected form a group consisting of amine, oxetane, epi sulfide, acrylate, methacrylate, thiol-acrylate, thiol-methacrylate, acrylamide, vinyl sulfide, vinyl ether, styrene, norborneyl, cyclopentadiene, and acryloxypropyl.

7. The waterborne coating formulation of claim 3, wherein the at least one hydrophilic group is selected from a group consisting of carboxyl group, ammonium group, and polyethylene glycol (PEG) group.

8. The waterborne coating formulation of claim 3, wherein the at least one substituent or an adducted hydrophilic group is selected from a group consisting of 3-mercapto-1-propane sulfonate salt, 2-mercaptoethanesulfonate salt, mercaptosuccinic acid, and 2,3-dimercaptopropanesulfonate salt.

9. The waterborne coating formulation of claim 1, wherein the one or more thoroughly modified polyhedral oligomeric silsesquioxanes are represented by the following formulae: 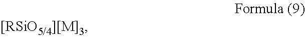
wherein R is an organic group, M is a cation.

10. The waterborne coating formulation of claim 9, wherein the one or more thoroughly modified polyhedral oligomeric silsesquioxanes comprise

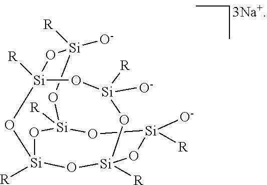

11. The waterborne coating formulation of claim 1, wherein the photo initiator is selected from a group consisting of aromatic phosphine oxides, diaromatic propanones, sulfonium salts, iodonium salts, selenium salts, ammonium salts, phosphonium salts, and transition metal complexes, while the thermal initiator is selected from a group consisting of organic peroxides, Lewis acid halides, transition metal complexes, and transition metal carbine complexes.

12. The waterborne coating formulation of claim 1, wherein the co-polymerizable reactive diluent is a curable compound selected from hydroxyl, thiol, amine, carboxyl, anhydride, epoxy, epoxy cyclohexane, epoxypropoxy, cycloaliphatic epoxy, epoxidized olefins, glycidyl ether, oxetane, episulfide, acrylate, methacrylate, thiol-acrylate, thiol-methacrylate, acrylamide, vinyl sulfide, styrene, vinyl ether, styrene, norborneyl and cyclopentadiene.

13. The waterborne coating formulation of claim 1, the at least one additive comprises a diluting solvent, a surfactant, or a leveling agent.

14. A waterborne, transparent and flexible hard-coating film comprising a substrate and a coating layer coated on the substrate, wherein the coating layer comprises the waterborne coating formulation of claim 1, and wherein the waterborne, transparent and flexible hard-coating film has a flexibility and durability for out fold and infold ability without permanent deformation or fracture.

15. The waterborne, transparent and flexible hard-coating film of claim 14, wherein the substrate comprises colorless polyimide (CPI), polyimide (PI), polyethylene terephthalate (PET), polyamide (PA), thermoplastic polyurethane (TPU), ultra-thin glass (UTG), poly (methyl methacrylate) (PMMA), polypropylene (PP), polycarbonate (PC), metal, glass, wood and marble.

16. The waterborne, transparent and flexible hard-coating film of claim 14, wherein the waterborne, transparent and flexible hard-coating film has a thickness of 1-100 μm and exhibits a pencil hardness of at least 4H.

17. The waterborne, transparent and flexible hard-coating film of claim 14, wherein the waterborne, transparent and flexible hard-coating film demonstrates a scratch resistance of 0.5 kg/cm² for over 30 passes.

18. The waterborne, transparent and flexible hard-coating film of claim 14, wherein the waterborne, transparent and flexible hard-coating film has a light transparency of at least 85%.

19. A method for preparing the waterborne, transparent and flexible hard-coating film of claim 14, comprising:
synthesizing a functionalized polymeric hard coating material, wherein the functionalized polymeric hard coating material comprises one or more thoroughly modified polyhedral oligomeric silsesquioxanes;
mixing the functionalized polymeric hard coating material with one or more photo/thermal initiators, at least one co-polymerizable reactive diluent and one or more additives to obtain a liquid mixture;
casting the liquid mixture to a substrate and drying coated substrate at a temperature ranging from 25 to 120° C.; and
curing the coated substrate to form the coating.

20. The method of claim 19, wherein step of curing comprises thermal curing or photo curing, and the coated substrate is cured under either visible light, UV irradiation exposure, LED irradiation, electron beam irradiation, or at elevated temperature ranging from 25° C. to 200° C.
